(19) United States
(12) Patent Application Publication
(10) Pub. No.: US 2021/0203489 A1
(43) Pub. Date: Jul. 1, 2021

(54) Ephemeral Broadcast Key Agreement

(71) Applicant: Arm IP Limited, Cambridge (GB)

(72) Inventors: Brendan James Moran, Histon (GB); Milosch Meriac, Cambridge (GB)

(73) Assignee: Arm IP Limited, Cambridge (GB)

(21) Appl. No.: 17/057,373

(22) PCT Filed: May 1, 2019
(86) PCT No.: PCT/GB2019/051204

§ 371 Date: Nov. 20, 2020

(30) Foreign Application Priority Data
May 25, 2018 (GB) 1808638.9

(51) Int. Cl. H04L 9/08

(52) U.S. Cl. CPC H04L 9/0825; H04L 9/088; H04L 2209/601; H04L 9/0861; H04L 9/0841

(57) ABSTRACT

A method for securely distributing content from a distributor to a plurality of receiving devices, each recipient creating recipient trusted ephemeral public private key pair and making the recipient trusted ephemeral public key available, the method comprising: generating a content encryption key for encrypting content to be distributed and encrypting content using the content encryption key; generating, for each recipient trusted ephemeral public key, a shared secret using the recipient trusted ephemeral public key and the distributor ephemeral private key; generating a plurality of encrypted per-recipient key slots, each encrypted per-recipient key slot generated by encrypting the content encryption key using a different shared secret of the plurality of shared secrets; creating a data structure comprising the distributor ephemeral public key, the encrypted content, and one or more encrypted per-recipient key slots; and transmitting the data structure to deliver the content to recipients associated with the device public keys from which the one or more encrypted per-recipient key slots are derived.

The present techniques relate to a mechanism to agree keys between a distributor and one or more recipients with minimal data exchange and forward secrecy.

A known firmware update delivery system delivering encrypted updates to multiple receiving devices on a network is open to decryption attacks and once an encryption for an update is broken then it can be used to gain access to subsequent encrypted updates.

According to a first technique there is provided a content distributor for securely distributing content to a plurality of receiving devices (recipients), each recipient creating a recipient trusted ephemeral public private key pair and making the recipient trusted ephemeral public key available, the content distributor comprising: a retriever for retrieving recipient trusted ephemeral public keys from repository, each recipient trusted ephemeral public key associated with a respective recipient; a distributor key factory for generating a distributor ephemeral key pair comprising a distributor ephemeral private key and a distributor ephemeral public key; a content key factory for generating a content encryption key for encrypting content to be distributed and encrypting content using the content encryption key; a shared secret factory for generating, for each recipient trusted ephemeral public key, a shared secret generated using the recipient trusted ephemeral public key and the distributor ephemeral private key; a key slot generator for generating a plurality of encrypted per-recipient key slots, each encrypted per-recipient key slot generated by encrypting the content encryption key using a different shared secret of the plurality of shared secrets; a data structure factory for creating a data structure comprising the distributor ephemeral public key, the encrypted content, and one or more encrypted per-recipient key slots; and a structure sender for transmitting the data structure to deliver the content to recipients associated with the device public keys from which the one or more encrypted per-recipient key slots are derived.

The recipient shared secret is created at both sides independently as part of the key exchange (for example a Diffie-Hellman key exchange). A recipient shared secret is an example of a per-recipient shared key and other examples of per-recipient shared encryption keys. Each recipient shared secret is used on the distributor side to encrypt the content key (also known as a per-content key) and on the receiver side to decrypt the content key back to decrypt the content. The content key is unique per payload and encrypted by the recipient shared secret into a per-recipient key slot (which is part of the manifest transmission).

According to a second technique there is provided a method for securely distributing content from a distributor to a plurality of receiving devices (recipients), each recipient creating a recipient trusted ephemeral public private key pair and making the recipient trusted ephemeral public key available, the method comprising: retrieving recipient trusted ephemeral public keys from repository, each recipient trusted ephemeral public key associated with a respective recipient; generating a distributor ephemeral key pair comprising a distributor ephemeral private key and a distributor ephemeral public key; generating a content encryption key for encrypting content to be distributed and encrypting content using the content encryption key; generating, for each recipient trusted ephemeral public key, a shared secret using the recipient trusted ephemeral public key and the distributor ephemeral private key; generating a plurality of encrypted per-recipient key slots, each encrypted per-recipient key slot generated by encrypting the content encryption key using a different shared secret of the plurality of shared secrets; creating a data structure comprising the distributor ephemeral public key, the encrypted content, and one or more encrypted per-recipient key slots; and transmitting the data structure to deliver the content to recipients associated with the device public keys from which the one or more encrypted per-recipient key slots are derived.

According to a third technique there is provided a receiving device for securely receiving content from a distributor, the receiving device comprising: a key factory for creating a recipient trusted ephemeral public private key pair; a key sender for sending the recipient trusted ephemeral public key to a repository; a data structure receiver for receiving a data structure comprising a distributor ephemeral public key, encrypted content, and one or more encrypted per-recipient key slots, each encrypted per-recipient key slot associated with a different recipient and each formed by encrypting a content encryption key using a recipient shared secret associated with the recipient, each recipient shared secret generated using associated recipient trusted ephemeral public key and the distributor ephemeral private key; a secret factory for recreating the recipient shared secret from the distributor ephemeral public key and the recipient trusted ephemeral private key; a key slot decoder for recreating the content encryption key by decrypting the encrypted per-recipient key slot of the one or more encrypted per-recipient key slots associated with recipient using the recreated recipient shared secret; and a content decoder for decrypting the encrypted content with the content encryption key.

According to a fourth technique there is provided a method in a receiving device for securely receiving content from a distributor, the method comprising: creating a recipient trusted ephemeral public private key pair; sending the recipient trusted ephemeral public key to a repository; receiving a data structure comprising a distributor ephemeral public key, encrypted content, and one or more encrypted per-recipient key slots, each encrypted per-recipient key slot associated with a different recipient and each formed by encrypting a content encryption key using a recipient shared secret associated with the recipient, each recipient shared secret generated using associated recipient trusted ephemeral public key and the distributor ephemeral private key; recreating the recipient shared secret from the distributor ephemeral public key and the recipient trusted ephemeral private key; recreating the content encryption key by decrypting the encrypted per-recipient key slot associated with the recipient using the recreated recipient shared secret; and decrypting the encrypted content with the content encryption key.

According to a fifth technique there is provided a system comprising a distributor, a plurality of receiving devices and a repository, the system for securely distributing content to the receiving devices, each receiving device comprising: a key factory for creating recipient trusted ephemeral public private key pair; a key sender for sending the recipient trusted ephemeral public key to a repository; a data structure receiver for receiving a data structure comprising the distributor ephemeral public key, the encrypted content, and one or more encrypted per-recipient key slots; a secret factory for recreating the recipient shared secret from the distributor ephemeral public key and the recipient trusted ephemeral private key; a key slot decoder for generating a content encryption key by decrypting the encrypted per-recipient key slot associated with recipient using the shared secret; a content decoder for decrypting the encrypted content with the content encryption key; and the distributor comprising: a retriever for retrieving recipient trusted ephemeral public keys from repository, each recipient trusted ephemeral public key associated with a respective recipient; a distributor key factory for generating a distributor ephemeral key pair comprising a distributor ephemeral private key and a distributor ephemeral public key; a content key factory for generating a content encryption key for encrypting content to be distributed and encrypting content using the content encryption key; a shared secret factory for generating, for each recipient trusted ephemeral public key, a shared secret using the recipient trusted ephemeral public key and the distributor ephemeral private key; a key slot generator for generating a plurality of encrypted per-recipient key slots, each encrypted per-recipient key slot generated by encrypting the content encryption key using a different shared secret of the plurality of shared secrets; a data structure factory for creating a data structure comprising the distributor ephemeral public key, the encrypted content, and one or more encrypted per-recipient key slots; and a structure sender for transmitting the data structure to deliver the content to recipients associated with the device ephemeral public keys from which the one or more encrypted per-recipient key slots are derived.

According to a sixth technique there is provided a method for securely distributing content from a distributor to a plurality of receiving devices, the method comprising: a receiver creating recipient trusted ephemeral public private key pair; the receiver sending the recipient trusted ephemeral public key to a repository; the distributor retrieving a plurality of recipient trusted ephemeral public keys from the repository, each recipient trusted ephemeral public key associated with a respective recipient; the distributor generating a distributor ephemeral key pair comprising a distributor ephemeral private key and a distributor ephemeral public key; the distributor further generating a content encryption key for encrypting content to be distributed and encrypting content using the content encryption key; the distributor further generating, for each recipient trusted ephemeral public key, a shared secret using the recipient trusted ephemeral public key and the distributor ephemeral private key; the distributor further generating a plurality of encrypted per-recipient key slots, each encrypted per-recipient key slot generated by encrypting the content encryption key using a different shared secret of the plurality of shared secrets; the distributor further creating a data structure comprising the distributor ephemeral public key, the encrypted content, and one or more encrypted per-recipient key slots and transmitting the data structure to deliver the content to recipients associated with the device public keys from which the one or more encrypted per-recipient key slots are derived; the receiving device receiving a data structure comprising the distributor ephemeral public key, the encrypted content, and one or more encrypted per-recipient key slots; the receiver device recreating the recipient shared secret from the distributor ephemeral public key and the recipient trusted ephemeral private key; the receiver recreating the content encryption key by decrypting the encrypted per-recipient key slot associated with the recipient by using the recreated shared secret; and the receiver device decrypting the encrypted content with the content encryption key.

According to a seventh technique there is provided a computer program stored on a computer readable medium and loadable into the internal memory of a digital computer, comprising software code portions, when said program is run on a computer, for performing the steps of any of the method claims.

Multiple embodiments will be described with reference to the accompanying figures of which:

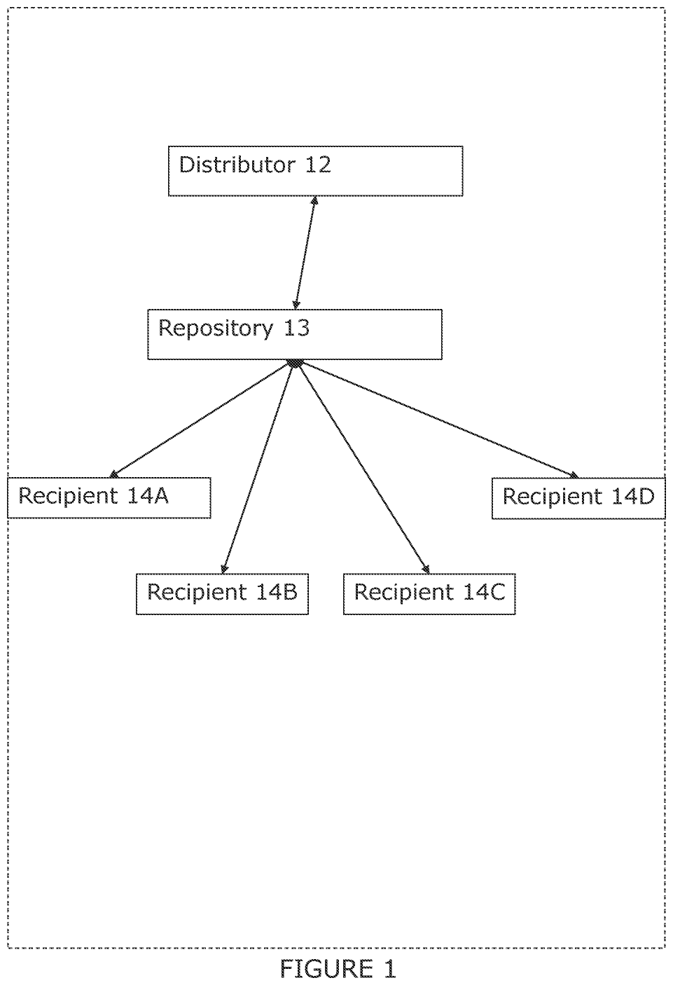

FIG. 1 is an example deployment diagram of a distributor; a repository and some receiving devices (recipients);

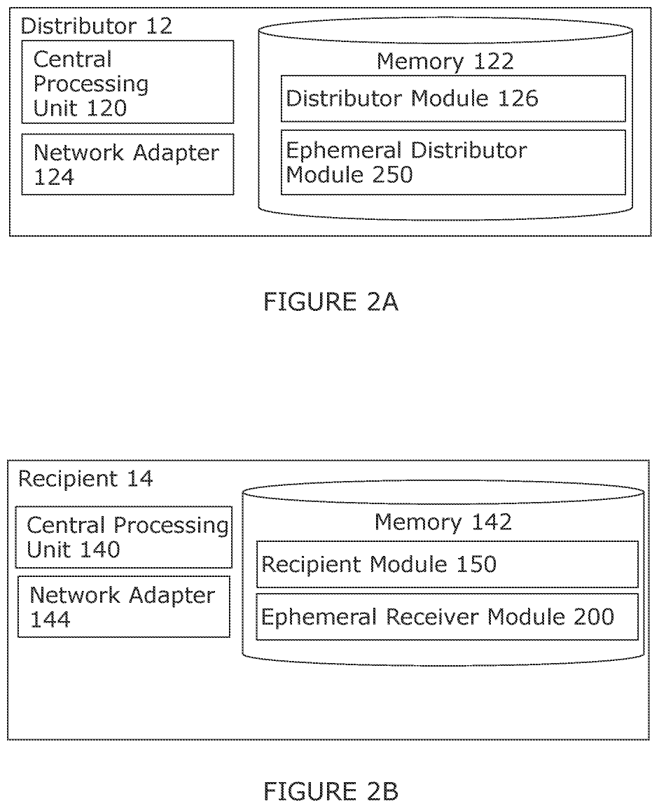

FIGS. 2A and 2B are deployment diagrams for a distributor and a generic recipient;

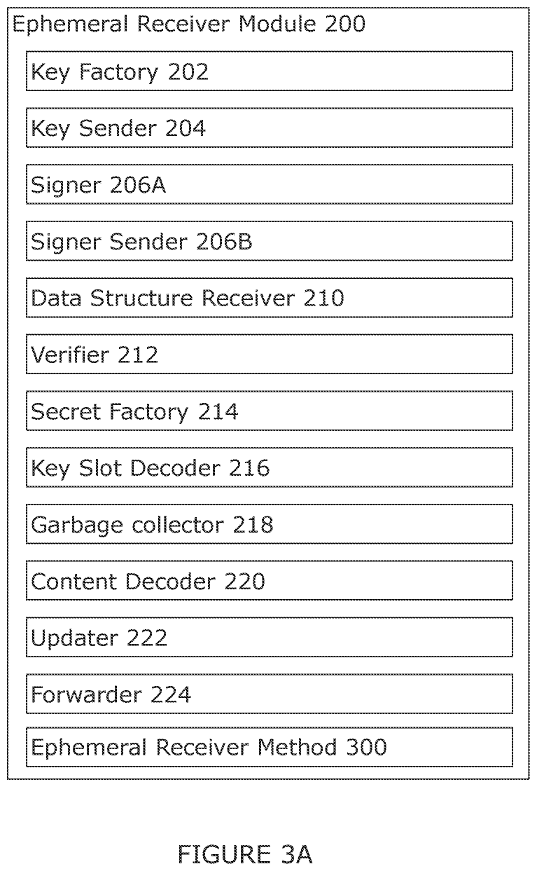

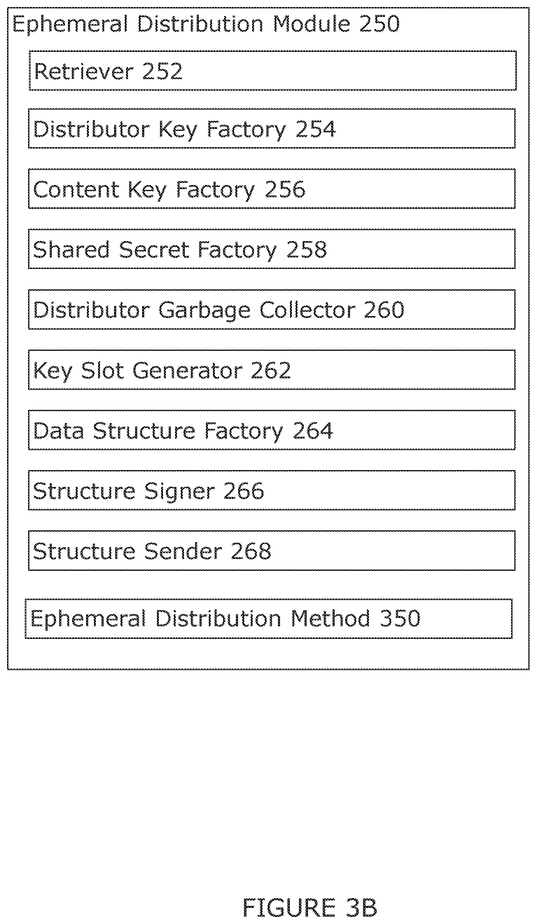

FIGS. 3A and 3B are component diagrams for an ephemeral receiver module and an ephemeral distribution module respectively;

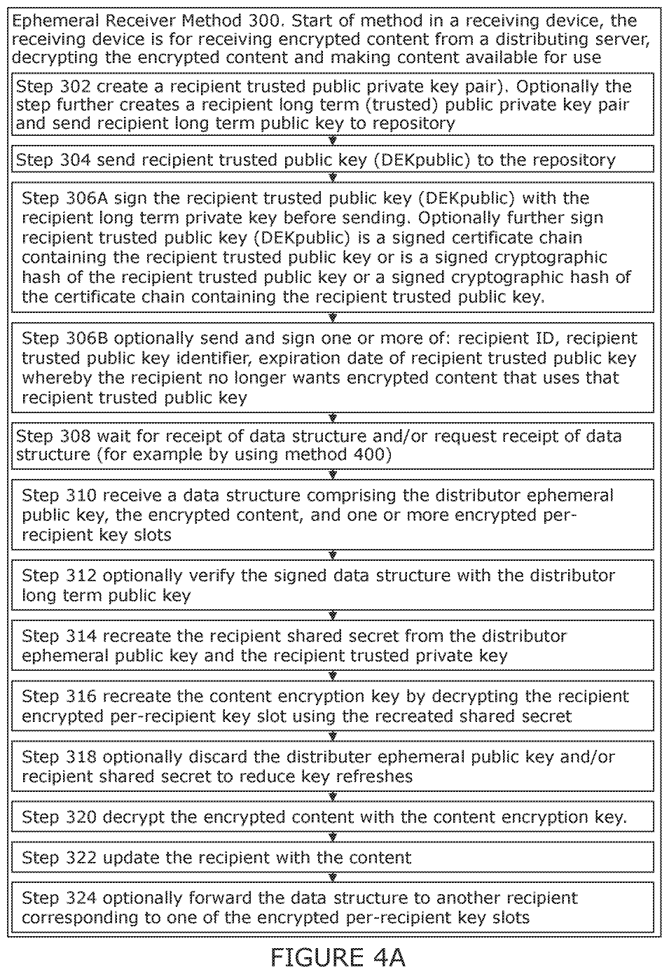

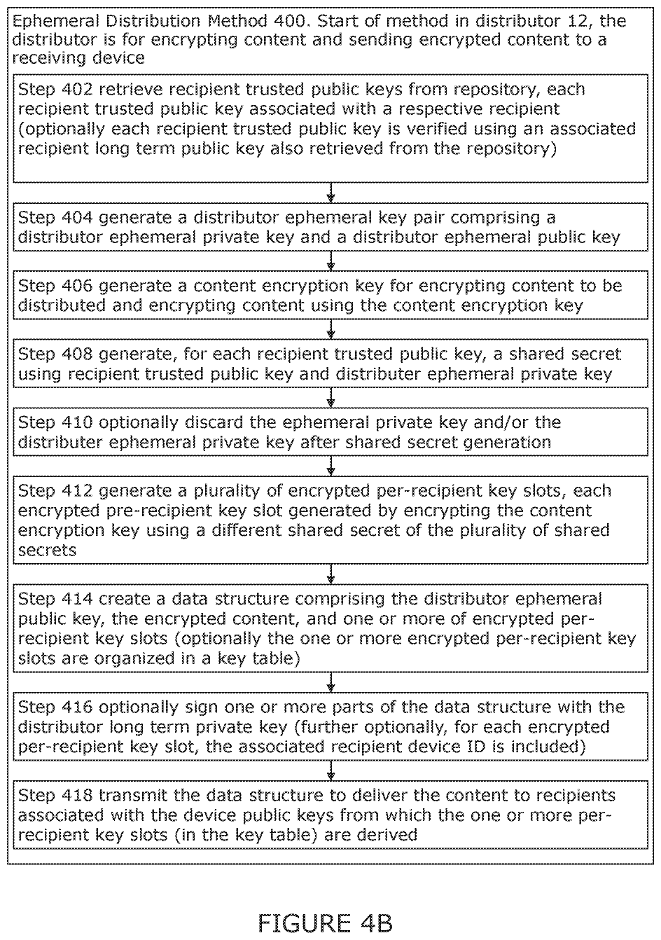

FIGS. 4A and 4B are method diagrams for an ephemeral receiver method and an ephemeral distribution method respectively;

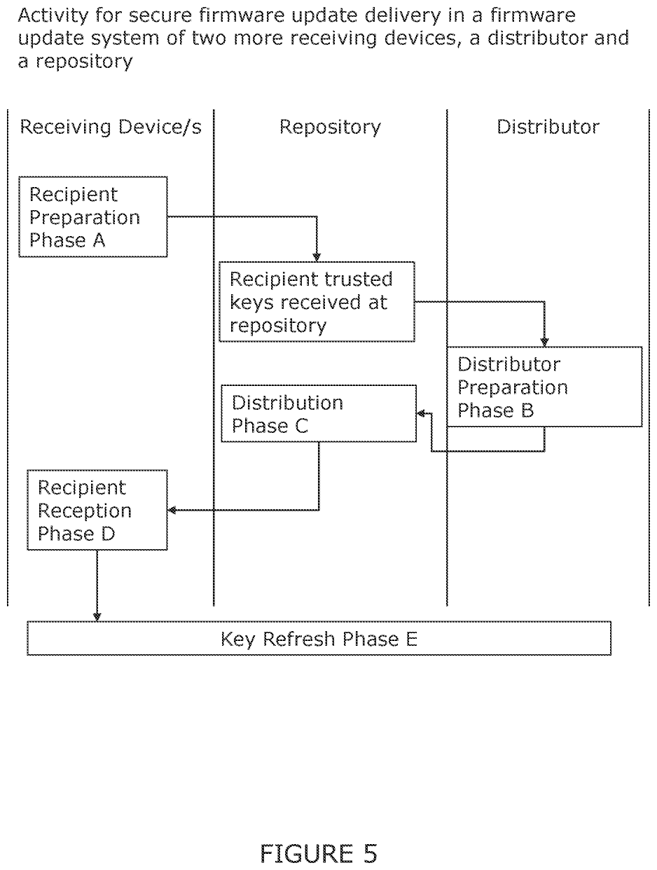

FIG. 5 is a swim lane diagram showing the ephemeral receiver method and ephemeral distribution method together;

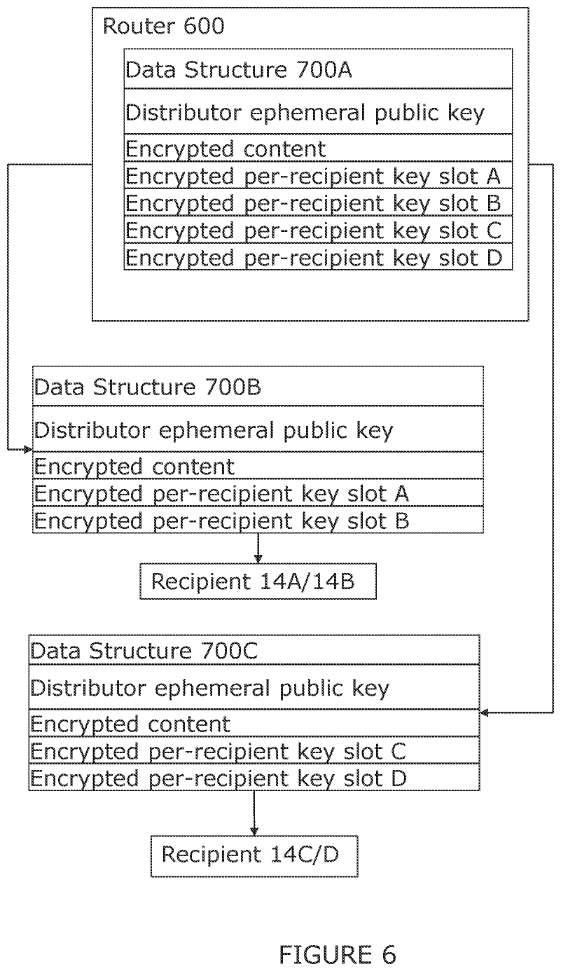

FIG. 6 is an example flow diagram of a data structure.

As used herein, the term ephemeral key means a key which lasts for a short period of time. An ephemeral key may be a single use key. However, an ephemeral key may be used more than once, for example to reduce the number of key refreshes required. Alternatively, an ephemeral key may have an expiry date/time, such that it is only valid for a finite period of time, or an ephemeral key may only be valid for a finite number of use cycles.

Referring to FIG. 1, an example deployment diagram comprises: distributor 12; repository 14 and recipients 14 (14A to 14D). Distributor 12 is for distributing software updates to recipients. Repository 13 is for storing and exchanging digital keys between the distributor and recipients 14. Recipients 14 (14A to 14D) are receiving devices for performing general computer functions in a network. Each recipient has a recipient module that is a controller for that recipients, each recipient module using program code that requires from time to time an update.

Referring to FIGS. 2A and 2B, respective deployment diagrams for a distributor 12 and recipient 14 of a first embodiment are described in terms of abstract inter-operational general purpose or special purpose computing processing system environments or configurations.

Distributor 12 is a computer processing system comprising: a central processor unit (CPU) 120; memory 122; and network adapter 124. Network adapter 124 is for communicating with recipients 14. Memory 122 comprises: distributor module 126 and ephemeral distributor module 250. Distributor module 126 is for co-ordinating functions of a distributor. Ephemeral distributor module 250 is for performing the method of the embodiment as described in more detail below.

Recipient 14 is a computer processing system comprising: a central processor unit (CPU) 140; memory 142; and network adapter 144. Network adapter 144 is for communicating with distributor and repository. Memory 122 comprises: recipient module 150 and ephemeral receiver module 200. Recipient module 126 is for co-ordinating functions of a recipient. Ephemeral receiver module 200 is for performing the method the embodiment as described in more detail below.

Examples of computing processing systems, environments, and/or configurations that may also be suitable for use as a gateway server 12, mobile gateway 14 and remote transceiver 16 include, but are not limited to, personal computer systems, server computer systems, thin clients, thick clients, hand-held or laptop devices, multiprocessor systems, microprocessor-based systems, network PCs, minicomputer systems, mainframe computer systems, and distributed computing environments that include any of the above systems or devices. A distributed computer environment includes a cloud computing environment for example where a gateway server is a third-party service performed by one or more of a plurality of computer processing systems.

Distributor 12 and receiver 14 respectively comprise program modules containing executable instructions for execution by a computer processor. Generally, program modules may include: routines; programs; objects; components; logic; and data structures that control performance of processor tasks or implement particular abstract data types. Computer processing systems may be embodied in distributed cloud computing environments where tasks are performed by remote processing devices that are linked through a communications network. In a distributed cloud computing environment, program modules may be located in both local and remote computer system storage media including memory storage devices.

CPUs 120 and 140 load executable instructions from respective modules to perform machine operations in response to the machine instructions. Such machine operations include: performing an operation on a value in a register (for example arithmetical or logical operations); moving a value from a register to a memory location directly and vice versa; and conditional or non-conditional branching. The CPUs can perform many different machine operations. The machine instructions are written in a machine code language which is referred to as a low-level computer language. A computer program written in a high-level computer language (also known as source code) needs to be compiled to a machine code program (also known as object code) before it can be executed by the processor. Alternatively, a machine code program such as a virtual machine or an interpreter can interpret a high-level language in terms of machine operations.

Memory 122 and 142 can be volatile memory and non-volatile or persistent memory. Volatile memory is used for faster applications and non-volatile memory is used to hold the data for longer. Each computer processing system may further include other removable and/or non-removable, volatile and/or non-volatile computer system storage media. By way of example only, persistent memory can be provided for reading from and writing to a non-removable, non-volatile magnetic media (not shown and typically a magnetic hard disk or solid-state drive). As will be further depicted and described below, memory 122 and 142 includes a program product module comprising components and instructions for carrying out the functions of the embodiments. Further program modules that support the preferred embodiment but are not shown include firmware, boot strap program, operating system, and support applications. Each of the operating system; support applications; other program modules; and program data; or some combination thereof may include an implementation of a networking environment.

Referring to FIG. 3A, a component diagram for ephemeral receiver module 200 of the embodiment is described. Ephemeral receiver module 200 comprises: key factory 202; key sender 204; signer 206A; signer sender 206B; data structure receiver 210; verifier 212; secret factory 214; key slot decoder 216; garbage collector 218; content decoder 220; updater 222; forwarder 224; and ephemeral receiver method 300.

Key factory 202 is for creating a recipient trusted ephemeral public private key pair (DEKpublic and DEKprivate) and for creating a recipient long-term (trusted) public private key pair and for sending recipient long-term public key to repository.

Key Sender 204 is for sending the recipient trusted ephemeral public key (DEKpublic) to the repository.

Signer 206A is for signing the recipient trusted ephemeral public key (DEKpublic) with the recipient long-term private key before sending.

Signer sender 206B is further for optionally sending and optionally signing one or more of: recipient ID, recipient trusted public key identifier, expiration date of recipient trusted ephemeral public key whereby the recipient no longer wants encrypted content that uses that recipient trusted ephemeral public key.

Data structure receiver 210 is for receiving a data structure comprising the distributor ephemeral public key, the encrypted content, and one or more encrypted per-recipient key slots.

Verifier 212 is for verifying the signed data structure with the distributor long-term public key.

Secret factory 214 is for creating the recipient shared secret from the distributor ephemeral public key and the recipient trusted ephemeral private key.

Key slot decoder 216 is for decrypting the encrypted content pre-recipient key slot associated with recipient.

Garbage collector 218 is for discarding the distributor's ephemeral public key and/or recipient shared secret to reduce key refreshes or keep them for a finite number of use cycles (further optionally as indicated by data structure metadata).

Content decoder Step 220 is for decrypting the encrypted content with the content encryption key.

Updater 222 is for updating the recipient with the content.

Forwarder 224 is for forwarding the data structure to another recipient corresponding to one of the encrypted per-recipient key slots.

Ephemeral receiver method 300 is described below.

Referring to FIG. 3B, a component diagram for ephemeral distribution module 250 of the embodiment is described. Ephemeral distribution module 250 comprises: retriever 252: distributor key factory 254; content key factory 256; shared secret factory 258; distributor garbage collector 260; key slot generator 262; data structure factory 264; structure signer 266; and structure sender 268.

Retriever 252 for retrieving recipient trusted ephemeral public keys from a repository, each recipient trusted ephemeral public key associated with a respective recipient and for verifying each recipient trusted ephemeral public key using an associated recipient long-term public key also retrieved from the repository.

Distributor key factory 254 is for generating a distributor ephemeral key pair comprising a distributor ephemeral private key and a distributor ephemeral public key.

Content key factory 256 is for generating a content encryption key for encrypting content to be distributed and encrypting content using the content encryption key.

Shared secret factory 258 is for generating, for each recipient trusted ephemeral public key, a shared secret using the recipient trusted ephemeral public key and the distributor ephemeral private key.

Distributor garbage collector 260 is for discarding the distributor ephemeral private key and the recipient trusted ephemeral public key after shared secret generation.

Key slot generator 262 is for generating a plurality of encrypted per-recipient key slots, each encrypted per-recipient key slot generated by encrypting the content encryption key using a different shared secret of the plurality of shared secrets.

Data structure factory 264 is for creating a data structure comprising the distributor ephemeral public key, the encrypted content, and one or more of encrypted per-recipient key slots and for organizing the encrypted per-recipient key slots in a key table.

Structure signer 266 is for signing one or more parts of the data structure with the distributor long-term private key.

Structure sender 268 is for transmitting the data structure to deliver the content to recipients associated with the device public keys from which the one or more encrypted per-recipient key slots (in the key table) are derived.

Ephemeral distribution method 350 is described below.

Referring to FIG. 4A, ephemeral receiver method 300 comprising logical process steps 302 to 324 is described. The method is for secure firmware update delivery in a firmware update system of two or more receiving devices, a distributor and a repository. The method is in a receiving device, the receiving device is for receiving encrypted content from a distributing server, decrypting the encrypted content and making content available for use.

Step 302 is for creating a recipient trusted ephemeral public private key pair (DEKpublic and DEKprivate). Optionally the step is further for creating a recipient long-term (trusted) public private key pair and send recipient long-term public key to repository, this is performed at each of a plurality of recipients. Trusted ephemeral keys are delivered by a trusted protocol which involves signing the delivery package with a further trusted key and verifying the signature on delivery. In most situations public keys are used to verify signatures but optionally an implementation uses shared symmetric keys for symmetric decryption or hash-based message authentication code (HMAC) secrets. Such verification occurs at the repository and/or at the distributor.

Step 304 is for sending the recipient trusted ephemeral public key (DEKpublic) to the repository. Optionally further signing the recipient ephemeral public key (or a hash of the recipient public key) using the private key to prevent attacks (for example man in the middle attacks) in transit or on the distribution server. The repository and distribution server can verify the recipient ephemeral public key using the recipient's long-term public key.

Step 306A is for optionally signing the recipient trusted ephemeral public key (DEKpublic) with the recipient long-term private key before sending. Optionally the signed recipient trusted ephemeral public key (DEKpublic) is a signed certificate chain containing the recipient trusted ephemeral public key or is a signed cryptographic hash of the recipient trusted ephemeral public key or a signed cryptographic hash of the certificate chain containing the recipient trusted ephemeral public key.

Step 306B is further for optionally sending and optionally signing one or more of: recipient ID, recipient trusted public key identifier, expiration date of recipient trusted ephemeral public key whereby the recipient no longer wants encrypted content that uses that recipient trusted ephemeral public key. The recipient ID is optional and/or may be contained in the signature. During recipient preparation, recipients send new ephemeral public keys to a repository. This would be commonly performed during scheduled polling and other unrelated communications with the server. Although an expiration date is described any type of expiration value is envisaged including relative and absolute time after an event (for example after receiving the recipient trusted ephemeral public key) or relative and absolute uses of the recipient trusted ephemeral public key.

Step 308, the recipient trusted ephemeral public keys are received at repository.

Since the recipient trusted ephemeral public key is transferred to the repository and is then retrieved from the repository by the distributor during the distributor preparation phase B, the latency of the entire system is reduced. This is because the recipients trusted ephemeral public key can be uploaded at any time, such that the distributor is not required to broadcast a request to a plurality of recipients for their public keys and wait for a response. The recipients may upload their trusted ephemeral public keys to the repository when a connection to the repository is made, for example periodically.

An additional benefit of the recipients uploading their trusted ephemeral public keys to the repository is that the distributor may target devices that are not online when the broadcast is prepared. This provides a significant benefit for rarely-connected or sleepy devices. In contrast, if the recipients uploaded their trusted ephemeral public keys directly to the distributor, then the preparation time would increase since the distributor would be required to wait for all devices to come online at least once before sending an update. Where connection establishment is expensive, such as in satellite devices, and a firmware update status message must be broadcast anyway, sending a new public key simultaneously cuts down on the number of communication sessions required, which can reduce the expense of preparing updates.

The recipient waits for a data structure (including encrypted content and encrypted per-recipient key slots) to be sent from a distributor and/or the recipient requests such a data structure from a distributor. The distribution process is performed by method 400.

Step 310 is for receiving a data structure comprising the distributor ephemeral public key, the encrypted content, and one or more encrypted per-recipient key slots. An identifier such as a key ID or public key hash is associated with each encrypted key slot so that each recipient can identify its own encrypted key slot.

Step 312 is for optionally verifying the signed data structure with the distributor long-term public key.

Step 314 is for recreating the recipient shared secret from the distributor ephemeral public key and the recipient trusted ephemeral private key.

Step 316 is for recreating the content encryption key by decrypting the encrypted pre-recipient key slot associated with the recipient using the recreated shared secret. A recipient can identify their key slot using a key ID/or public key hash stored in the data structure.

Step 318 is for optionally discarding the distributor's ephemeral public key and/or the recipient shared secret to reduce key refreshes or keep them for a finite number of use cycles. Further optionally, the decision to discard is as indicated by data structure metadata.

Step 320 is for decrypting the encrypted content with the content encryption key.

Step 322 is for updating the recipient with the content.

Step 324 is for optionally forwarding the data structure to another recipient corresponding to one of the encrypted per-recipient key slots or alternately duplicate the data structure comprising a subset of the encrypted pre-recipient key slots and forward the duplicated data structure to a recipient corresponding to one of the encrypted per-recipient key slots in the subset.

Referring to FIG. 4B, ephemeral distribution method 400, comprising logical process steps 402 to 418, is described.

Step 402 is for retrieving recipient trusted ephemeral public keys from repository, each recipient trusted ephemeral public key associated with a respective recipient (optionally each recipient trusted ephemeral public key is verified using an associated recipient long-term public key also retrieved from the repository).

Step 404 is for generating a distributor ephemeral key pair comprising a distributor ephemeral private key and a distributor ephemeral public key.

Step 406 is for generating a content encryption key for encrypting content to be distributed and encrypting content using the content encryption key.

Step 408 is for generating, for each recipient trusted ephemeral public key, a shared secret using the recipient trusted ephemeral public key and the distributor ephemeral private key.

Step 410 is for optionally discarding the distributor ephemeral private key and/or the recipient trusted ephemeral public key after shared secret generation. Preferably the distributor ephemeral private key and recipient trusted ephemeral public key are not stored in non-volatile memory and more preferably some or all the keys are created in non-exportable memory that cannot be accessed outside of the distributor. The key table header might contain a proof (certificate) that the key used was a key marked as non-exportable in an adequately secure non-exportable memory. An example of non-exportable memory is a hardware security module for safeguarding and managing digital keys for crypto-processing, such modules can come in the form of plug-in hardware that attached directly into a computer processing device such as the distributor.

Step 412 is for generating a plurality of encrypted per-recipient key slots, each encrypted per-recipient key slot generated by encrypting the content encryption key using a different shared secret of the plurality of shared secrets.

This step decouples the generation of ephemerally encrypted content from device communication; generation can be performed offline which simplifies communication and allows low power operation of the targeted devices.

Step 414 is for creating a data structure comprising the distributor ephemeral public key, the encrypted content, and one or more of encrypted per-recipient key slots (optionally the one or more encrypted per-recipient key slots are organized in a key table). An identifier such as a key ID or public key hash associated with each encrypted key slot is included in the structure so that each recipient can identify its own encrypted key slot

Step 416 is for optionally signing one or more parts of the data structure with the distributor long-term private key. Further optionally, for each encrypted per-recipient key slot, the associated recipient device ID is included to identify the correct slot at the recipient and to allow easier splitting of data structures into sub-structures. The distributor can sign any combination of: the recipient device ID; the recipient encryption public key ID (opaque); the ephemeral public key of the distributor; the plaintext of the CEK (omitted in the data structure); the digest of the plaintext of the CEK; and/or the ciphertext of the CEK. There are options for signing, the distributor might decide to sign all device key entries with one signature, either the recipient device ID or the public encryption key or both can be outside of the signature, the signature might be left out altogether. Authenticated decryption might be used by the receiver instead.

Step 418 is for transmitting the data structure to deliver the content to recipients associated with the device ephemeral public keys from which the one or more encrypted per-recipient key slots (in the key table) are derived. The distributor attaches its ephemeral public key BEKpublic to the key table (“key table header”)—signing the ephemeral public key with its long-term key—and combining that with encrypted per-recipient key slot table entries. In case of IES, the step attaching BEKpublic can be skipped, as IES already contains the BEKpublic public key entry. This step provides a single-step delivery of content keeping the ephemeral guarantee for both sides since in case that the content and the long-term keys of any side are compromised then an adversary will not be able to decrypt the content.

For software implementations, security measures apply here, the memory used for the ephemeral distributor key can be pinned into the internal CPU cache, so it will not be ever visible on the potentially unencrypted external RAM.

Referring to FIG. 5, an embodiment is described in terms of: recipient preparation phase A; distributor preparation phase B; distribution phase C; recipient reception phase D; and key refresh phase E.

During recipient preparation phase A, recipients send new ephemeral public keys to a repository, this would be commonly performed during scheduled polling and other unrelated communications with the server.

By using a recipient ephemeral public private key pair, which is only valid for a short period of time, for example, by defining an expiry date/time, or which is only valid for a single use or a predefined number of use cycles, the recipient device is protected from exposure to malicious attacks. For example, if a recipient ephemeral private key were exposed, then since the ephemeral public private key pair is only valid for a short period of time, exposure of the ephemeral private key does not expose all of the pervious communications of the recipient device, only those of the exposed ephemeral public private key pair.

During distributor preparation: the distributor queries device ephemeral public keys from the repository; creates a new key pair; creates a shared secret for each recipient; and encrypts a new content encryption key (CEK) with each device's shared secret. These shared secrets can be reused until the key refresh phase. The author deletes its private key and all shared secrets after finishing the key table creation.

During the distribution phase B: the distributor sends the recipient ID; recipient key ID; distributor public key; and encrypted CEK to each recipient. During key refresh phase E, each recipient deletes its private key and shared secret.

During the recipient preparation phase A: each recipient creates a new trusted ephemeral private key DEKprivate and its ephemeral public counterpart DEKpublic; the recipient signs content with the long-term key; the recipient sends this signed data to a repository, for example during scheduled interactions like polling for firmware updates; and the repository stores the signed key information for later usage. The content comprises: recipient device ID (optional, in most cases contained in the signature instead); recipient trusted ephemeral public key DEKpublic or a certificate (chain) containing it (or a cryptographic hash of these); recipient encryption public key ID (opaque, optional—see notes below); optional: expiration date of this entry (“don't bother sending me anything encrypted to this entry after that date”).

Distributor preparation phase B comprises: the distributor queries all targeted recipient ephemeral public keys from the repository as stored in the previous steps; and the distributor verifies all recipient signatures against known recipient long-term public keys.

Distribution phase C comprises: the distributor creating a new ephemeral private encryption key BEKprivate and its public counterpart BEKpublic; the distributor creating a new content encryption key (CEK); the distributor sending the ciphertext of the content to the repository; for each recipient encrypting CEK using Integrated Encrypted Scheme (IES or Elliptical Curve Integrated Encrypted Scheme (ECIES) in case of elliptical curve cryptography (ECC)) using the collected ephemeral public device keys (“key table entry”); and the distributor signing the combination of factors. The factors comprise: the recipient device ID; the recipient encryption public key ID (opaque) PKID; the ciphertext, plaintext, or digest of the plaintext of the CEK (based on IES, ECIES etc.).

At this point the distributor discards the private key BEKprivate, ideally that key is never stored in non-volatile memory. In the ideal case the original key was created in non-exportable memory so that it will not be accessible on the outside. The key table header might contain a proof (certificate) that the key used was marked as non-exportable in an adequately secure non-exportable memory; for software implementations, usual security measures apply here, the memory used for the ephemeral distributor key can be pinned into the internal CPU cache, so it won't be ever visible on the potentially unencrypted external RAM.

Distribution phase C further comprises: the distributor attaching its ephemeral public key BEKpublic to the key table (“key table header”), signing the ephemeral public key with its long-term key and combining that with per-device entries key table entries. In case of IES, the step attaching BEKpublic can be skipped, as IES already contains the BEKpublic public key entry; the distributor sends the above key table structure with the mentioned signed ephemeral public key to a content delivery network (CDN) (the key table structure); and the CDN distributes the distributors key table structure to all recipients. Devices or gateways can now download one or more key table entries and the key table header to perform key updates from the CDN (key table and encrypted payloads can be pushed to the devices or pulled by the devices). As these downloads travel down a mesh network, the table can be split further down, but keeping the header.

At any point in time multiple keys can be active (and uploaded at the repository) to reflect relations with multiple parties or delay between key table creation and key table delivery (with one or more possible key refreshes on the device side). The optional recipient public key ID is used in this case to disambiguate the used public key. If the signature format already provides such an identifier, or only one key is used during the update, that identifier can be dropped.

In recipient phase D: the recipient either extracts their own key table entry plus the key table header from a broadcast of the combination of the above or receives these two items in a point-to-point communication (push or pull); the recipient verifies the key table against a certificate chain leading to the long-term key signed key table header and key table entry (this is optional in case the encrypted/decrypted payload can be authenticated by other means).

Recipient phase D continues: the recipient uses his own ephemeral key to extract the CEK for decrypting (optional authenticated decrypt) future payloads in case multiple ephemeral keys are active for the device, the device can either try all of them or (can be pushed to the devices or pulled by the devices) identify the correct key by the optional PKID as passed on by the distributor.

Recipient phase D continues: a firmware update can be directly concatenated with one or more key table entries and the key table header; very efficient distribution of firmware is allowed within the same object transmission or broadcast distribution; the receiving device can at this point discard the ephemeral key or decide to use it multiple times before discarding it to reduce key refreshes. Note that the distributor and repository can be a single entity, in case the repository can be trusted. For example, the distributor can provide the trusted repository with the CEK. In this case, all other “distributor” actions are taken by the repository. Optionally, distribution can be performed more than one time between key refresh cycles by caching BEKprivate/BEKpublic and/or DEKprivate/DEKpublic.

In key refresh phase E, a key-refresh or key-discard can be triggered by: use of the key (single use keys); a key expiration timeout (fixed-duration or fixed usage-count keys); and an external trigger (for example: manual reset, intrusion detection). In a key refresh: each recipient destroys its (encryption) private key and any cached shared secrets; each recipient performs a new recipient preparation; the distributor destroys its (encryption) private key and any cached shared secrets; and distributor instigates a new distributor preparation phase.

Referring to FIG. 6, an example flow diagram of a data structure is described.

Router 600 receives data structure 700A. Data structure 700A comprises: a distributor ephemeral public key; encrypted content; and encrypted per-recipient key slots A, B, C and D. Router 600 splits the data structure 700A into sub-structures, data structure 700B and 700C. The sub structures contain the same distributor ephemeral public key and encrypted content but data structure 700B further comprises encrypted per-recipient key slots A and B and data structure 700C further comprise encrypted per-recipient key slots C and D. Data structure 700B is forwarded to recipient 14A or 14B and data structure 700C is forwarded to recipient 14C or 14D.

Each recipient can verify the signed data structure with the distributor long-term public key. The recipient can then create the recipient shared secret from the distributor ephemeral public key and the recipient trusted ephemeral private key. The encrypted content is then decrypted with pre-recipient key slot associated with recipient. The recipient can then discard the distributor's ephemeral public key. The encrypted content can then be decrypted with the content encryption key the recipient updated with the content. If recipient 14A initially receives the data structure, then the data structure can be forwarded to another recipient (for example 14B) corresponding to one of the encrypted per-recipient key slots.

Although the description herein refers to using the recipients trusted ephemeral public key for secure software updates, the uploading of the recipients trusted ephemeral public key to the repository is independent from the use of the recipients trusted ephemeral public key. The recipient trusted ephemeral public key which is uploaded to the repository may not have been uploaded to the repository for a specific task, and may be used by any system for secure communication with the recipient device.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and procedural programming languages.

For example, program code for carrying out operations of the present techniques may comprise source, object or executable code in a programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on a computer, partly on the computer and partly on a remote computer or entirely on the remote computer or server. In the latter scenario, the remote computer may be connected to the computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

1. A content distributor for securely distributing content to a plurality of recipients, each recipient creating a recipient trusted ephemeral public private key pair and making the recipient trusted ephemeral public key available, the content distributor comprising:
a retriever for retrieving recipient trusted ephemeral public keys from a repository, each recipient trusted ephemeral public key associated with a respective recipient;
a distributor key factory for generating a distributor ephemeral key pair comprising a distributor ephemeral private key and a distributor ephemeral public key;
a content key factory for generating a content encryption key for encrypting content to be distributed and encrypting the content using the content encryption key;
a shared secret factory for generating, for each recipient trusted ephemeral public key, a shared secret using the recipient trusted ephemeral public key and the distributor ephemeral private key;
a key slot generator for generating a plurality of encrypted per-recipient key slots, each encrypted per-recipient key slot generated by encrypting the content encryption key using a different shared secret of the plurality of shared secrets;
a data structure factory for creating a data structure comprising the distributor ephemeral public key, the encrypted content, and one or more encrypted per-recipient key slots; and
a structure sender for transmitting the data structure to deliver the content to recipients associated with the device ephemeral public keys from which the one or more encrypted per-recipient key slots are derived.

2. (canceled)

3. A method for securely distributing content from a distributor to a plurality of recipients, each recipient creating recipient trusted ephemeral public private key pair and making the recipient trusted ephemeral public key available, the method comprising:
retrieving recipient trusted ephemeral public keys from a repository, each recipient trusted ephemeral public key associated with a respective recipient;
generating a distributor ephemeral key pair comprising a distributor ephemeral private key and a distributor ephemeral public key;
generating a content encryption key for encrypting content to be distributed and encrypting content using the content encryption key;
generating, for each recipient trusted ephemeral public key, a shared secret using the recipient trusted ephemeral public key and the distributor ephemeral private key;
generating a plurality of encrypted per-recipient key slots, each encrypted per-recipient key slot generated by encrypting the content encryption key using a different shared secret of the plurality of shared secrets;
creating a data structure comprising the distributor ephemeral public key, the encrypted content, and one or more encrypted per-recipient key slots; and
transmitting the data structure to deliver the content to recipients associated with the device ephemeral public keys from which the one or more encrypted per-recipient key slots are derived.

4. A method according to claim 3 further comprising discarding the distributor ephemeral private key and/or the recipient trusted ephemeral public key after shared secret generation.

5. A method according to claim 3 further comprising associating, in the data structure, each encrypted per-recipient key slots with a recipient key ID or public key hash so that a recipient can identify their own encrypted per-recipient key slot.

6. A method according to claim 3 further comprising one or more of signing the data structure with a distributor long-term private key and signing one or more parts of the data structure at the distributor for later verification at a recipient.

7. A method according to claim 3 further comprising creating two or more data structures comprising different subsets of the encrypted per-recipient key slots and forwarding each data structure to a recipient corresponding to one of the encrypted per-recipient key slots in its respective subset of encrypted content keys.

8. (canceled)

9. A method according to claim 3 further comprising verifying each recipient trusted ephemeral public key using an associated recipient long-term public key also retrieved from the repository.

10. A receiving device for securely receiving content from a distributor, the receiving device comprising:
a key factory for creating a recipient trusted ephemeral public private key pair;
a key sender for sending the recipient trusted ephemeral public key to a repository;
a data structure receiver for receiving a data structure comprising a distributor ephemeral public key, encrypted content, and one or more encrypted per-recipient key slots, each encrypted per-recipient key slot associated with a different recipient and each formed by encrypting a content encryption key using a recipient shared secret associated with the recipient, each recipient shared secret generated using associated recipient trusted ephemeral public key and the distributor ephemeral private key;
a secret factory for recreating the recipient shared secret from the distributor ephemeral public key and the recipient trusted ephemeral private key;
a key slot decoder for recreating the content encryption key by decrypting the encrypted per-recipient key slot of the one or more encrypted per-recipient key slots associated with the recipient using the recreated recipient shared secret;
a content decoder for decrypting the encrypted content with the content encryption key.

11. (canceled)

12. A method in a receiving device for securely receiving content from a distributor, the method comprising:
creating a recipient trusted ephemeral public private key pair;
sending the recipient trusted ephemeral public key to a repository;
receiving a data structure comprising a distributor ephemeral public key, encrypted content, and one or more encrypted per-recipient key slots, each encrypted per-recipient key slot associated with a different recipient and each formed by encrypting a content encryption key using a recipient shared secret associated with the recipient, each recipient shared secret generated using associated recipient trusted ephemeral public key and the distributor ephemeral private key;
recreating the recipient shared secret from the distributor ephemeral public key and the recipient trusted ephemeral private key;
recreating the content encryption key by decrypting the encrypted per-recipient key slot associated with the recipient using the recreated recipient shared secret; and
decrypting the encrypted content with the content encryption key.

13. A method according to claim 12 further comprising updating the recipient with the content.

14. A method according to claim 12 or 13 further comprising forwarding the data structure to another recipient corresponding to one of the encrypted per-recipient key slots.

15. A method according to claim 12 or 13 further comprising duplicating the data structure comprising a subset of the encrypted per-recipient key slots and forwarding the duplicated data structure to a recipient corresponding to one of the encrypted per-recipient key slots in the subset.

16. A method according to claim 12 further comprising:
creating a further recipient public private key pair and sending the further recipient public key to the repository; and
signing the recipient trusted ephemeral public key (DEKpublic) with the further recipient private key before sending whereby the recipient trusted ephemeral public key can be verified using the further recipient public key.

17. (canceled)

18. A method according to claim 12 further comprising including an expiration value of recipient trusted ephemeral public key with the recipient trusted ephemeral public key whereby the recipient no longer wants encrypted content that uses that recipient trusted ephemeral public key when the expiration value has been exceeded.

19. A method according to claim 12 further comprising verifying the signed data structure with the distributor public key.

20. A method according to claim 12 further comprising one or more of discarding the distributor ephemeral public key and/or the recipient shared secret after use or as indicated by data structure metadata and discarding the distributor ephemeral private key after creating the content encryption key.

21. (canceled)

22. A method according to claim 12 wherein the data structure comprises a reference to the signed certificate chain containing the recipient trusted ephemeral public key or the signed cryptographic hash of the recipient trusted ephemeral public key or the signed cryptographic hash of the certificate chain containing the recipient trusted ephemeral public key so that the recipient can fetch the recipient trusted ephemeral public key to confirm validity.

23. A method according to claim 10 further signing the recipient trusted ephemeral public key using a private key.

24. (canceled)

25. (canceled)

26. A computer program stored on a computer readable medium and loadable into the internal memory of a digital computer, comprising software code portions, when said program is run on a computer, for performing the method of claim 3.

27. A computer program stored on a computer readable medium and loadable into the internal memory of a digital computer, comprising software code portions, when said program is run on a computer, for performing the method of claim 12.
